(19) United States
(12) Patent Application Publication
(10) Pub. No.: US 2025/0093030 A1
(43) Pub. Date: Mar. 20, 2025

(54) MULTI-PIECE INJECTOR NOZZLE FOR A TURBINE ENGINE

(71) Applicant: RTX Corporation, Farmington, CT (US)

(72) Inventor: Matthew D. Bowers, Biddeford, ME (US)

(21) Appl. No.: 18/368,901

(22) Filed: Sep. 15, 2023

(51) Int. Cl. F23R 3/04

(52) U.S. Cl. CPC F23R 3/04; F05D 2220/32; F05D 2230/10; F05D 2230/60

(57) ABSTRACT

An apparatus is provided for a turbine engine. This turbine engine apparatus includes an annular nozzle. The annular nozzle includes an inner monolithic body and an outer monolithic body. The inner monolithic body includes an inner shroud and a plurality of vanes. The inner shroud extends axially along and circumferentially around an axis. The vanes are arranged circumferentially about the axis in an array. Each of the vanes projects radially out from the inner shroud to a respective outer distal end. The outer monolithic body is radially outboard of and circumscribes the inner monolithic body. The outer monolithic body is configured as or otherwise includes an outer shroud. The outer shroud extends axially along and circumferentially around the axis. The outer shroud radially engages each of the vanes at the respective outer distal end.

### GOVERNMENT LICENSE RIGHTS

This invention was made with Government support awarded by the United States. The Government has certain rights in this invention.

### BACKGROUND OF THE DISCLOSURE

### 1. Technical Field

This disclosure relates generally to a gas turbine engine and, more particularly, to a nozzle for the gas turbine engine.

### 2. Background Information

A gas turbine engine includes various nozzles for directing air, which nozzle may include an air injector nozzle such as a tangential onboard injection (TOBI) nozzle. A typical air injector nozzle is formed as a single unitary body via casting. While known air injector nozzles and nozzle manufacturing techniques have various benefits, there is still room in the art for improvement.

### SUMMARY OF THE DISCLOSURE

According to an aspect of the present disclosure, an apparatus is provided for a turbine engine. This turbine engine apparatus includes an annular nozzle. The annular nozzle includes an inner monolithic body and an outer monolithic body. The inner monolithic body includes an inner shroud and a plurality of vanes. The inner shroud extends axially along and circumferentially around an axis. The vanes are arranged circumferentially about the axis in an array. Each of the vanes projects radially out from the inner shroud to a respective outer distal end. The outer monolithic body is radially outboard of and circumscribes the inner monolithic body. The outer monolithic body is configured as or otherwise includes an outer shroud. The outer shroud extends axially along and circumferentially around the axis. The outer shroud radially engages each of the vanes at the respective outer distal end.

According to another aspect of the present disclosure, another apparatus is provided for a turbine engine. This turbine engine apparatus includes a tangential onboard injector nozzle. The tangential onboard injector nozzle includes an inner nozzle structure and an outer nozzle structure. The inner nozzle structure includes an inner shroud and a plurality of vanes formed integral with the inner shroud. The inner shroud extends axially along and circumferentially around an axis. The vanes are arranged circumferentially about the axis in an array. Each of the vanes projects radially outward away from the axis from the inner shroud. The outer nozzle structure is radially outboard of, circumscribes and is mounted to the inner nozzle structure. The outer nozzle structure is configured as or otherwise includes an outer shroud. The outer shroud extends axially along and circumferentially around the axis. The outer shroud is abutted radially against each of the vanes.

According to still another aspect of the present disclosure, a method is provided for manufacturing a nozzle for a turbine engine. During this method, a forged inner ring is machined to form an inner nozzle structure. The inner nozzle structure includes an inner shroud and a plurality of vanes. The inner shroud extends axially along and circumferentially around an axis. The vanes are arranged circumferentially about the axis in an array. Each of the vanes projects radially out from the inner shroud. A forged outer ring is machined to form an outer nozzle structure. The outer nozzle structure is configured as or otherwise includes an outer shroud. The outer nozzle structure is mounted to the inner nozzle structure to form the nozzle. The outer shroud circumscribes and is radially abutted against the vanes.

The vanes may include a first vane. The first vane may have an axial length along the axis. The first vane may have a radial height between the inner shroud and the outer shroud which is less than the axial length.

The vanes may include a first vane. The first vane may have a circumferential width about the axis. The first vane may have a radial height between the inner shroud and the outer shroud which is less than the circumferential width.

The vanes may include a first vane. The first vane may have a lateral thickness. The first vane may have a radial height between the inner shroud and the outer shroud which is less than the lateral thickness.

The inner shroud may form an outer peripheral boundary of a flowpath through the annular nozzle. The inner shroud may include a first surface and a second surface. The first surface may extend circumferentially around the axis and may be upstream of the second surface along the flowpath. The second surface may extend circumferentially around the axis and may be radially outboard of the first surface. The vanes may project radially out from the second surface.

The first surface may be a first cylindrical surface. In addition or alternatively, the second surface may be a second cylindrical surface.

The outer shroud may form an inner peripheral boundary of a flowpath through the annular nozzle. The outer shroud may include a first surface and a second surface. The first surface may extend circumferentially around the axis and may be upstream of the second surface along the flowpath. The second surface may extend circumferentially around the axis and may be radially inboard of the first surface. The second surface may radially abut each of the vanes at the respective outer distal end.

The first surface may be a first cylindrical surface. In addition or alternatively, the second surface may be a second cylindrical surface.

The inner shroud may form an outer peripheral boundary of a flowpath through the annular nozzle. The outer shroud may form an inner peripheral boundary of the flowpath through the annular nozzle. Each of the vanes may extend radially across the flowpath. A radial height of the flowpath may decrease as the flowpath extends axially within the annular nozzle towards the vanes.

The outer monolithic body may be mechanically fastened to the inner monolithic body.

The outer monolithic body may be attached to the inner monolithic body by an interference fit between the outer shroud and the plurality of vanes.

A fastener may project radially through the outer monolithic body and partially into the inner monolithic body.

A fastener may project radially through the outer monolithic body and the inner monolithic body.

A fastener may extend radially in an outer aperture of the outer monolithic body and radially an inner aperture of the inner monolithic body.

The outer aperture of the outer monolithic body may extend radially through the outer shroud.

The inner aperture of the inner monolithic body may extend radially in a first of the vanes.

The inner aperture of the inner monolithic body may extend radially through a first of the vanes and into the inner shroud.

The inner monolithic body may also include an inner flange. The inner flange may be axially spaced from the vanes. The inner flange may project radially inward towards the axis from the inner shroud.

The outer monolithic body may also include an outer flange. The outer flange may be axially aligned with the vanes. The outer flange may project radially outward away from the axis from the outer shroud.

The annular nozzle may be configured as a tangential onboard injector.

The turbine engine apparatus may also include a compressor section, a combustor section, a turbine section and a flowpath extending sequentially through the compressor section, the combustor section and the turbine section. The flowpath may be disposed radially outboard of the annular nozzle.

The turbine engine apparatus may also include a bladed rotor rotatable about the axis. The annular nozzle may be configured to direct air bled from the flowpath to the bladed rotor.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a partial schematic illustration of a powerplant for an aircraft.

FIG. 2 is a partial schematic illustration of an assembly within the powerplant.

FIG. 3 is a partial sectional illustration of an air injector nozzle.

FIG. 4 is a perspective illustration of an inner nozzle structure for the injector nozzle.

FIG. 5 is a perspective illustration of an outer nozzle structure for the injector nozzle.

FIG. 6 is a partial sectional illustration of a connection between the inner nozzle structure and the outer nozzle structure.

FIG. 7 is a partial side illustration of the inner nozzle structure.

### DETAILED DESCRIPTION

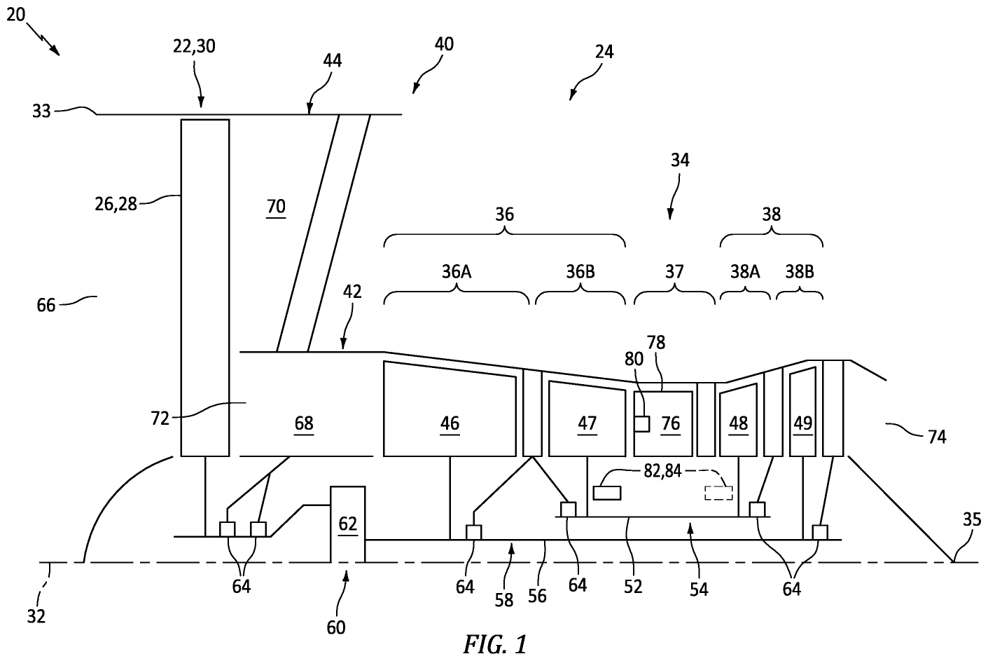

FIG. 1 illustrates a powerplant 20 for an aircraft. The aircraft may be an airplane, a helicopter, a drone (e.g., an unmanned aerial vehicle (UAV)) or any other manned or unmanned aerial vehicle or system. The powerplant 20 may be configured as, or otherwise included as part of, a propulsion system for the aircraft. The powerplant 20 may also or alternatively be configured as, or otherwise included as part of, an electrical power system for the aircraft. The powerplant 20 of FIG. 1 includes a mechanical load 22 and a gas turbine engine 24 configured to power operation of the mechanical load 22.

The mechanical load 22 of FIG. 1 includes at least one driven rotor 26. This driven rotor 26 may be configured as a bladed propulsor rotor for the aircraft propulsion system. The propulsor rotor may be a ducted propulsor rotor or an open propulsor rotor; e.g., an un-ducted propulsor rotor. Examples of the ducted propulsor rotor include a fan rotor 28 for a turbofan propulsion system, and a (e.g., first stage) compressor rotor for a turbojet propulsion system. Examples of the open propulsor rotor include a propeller rotor for a turboprop propulsion system, a rotorcraft rotor (e.g., a main helicopter rotor) for a turboshaft propulsion system, a pusher fan rotor for a pusher fan propulsion system, and a propfan rotor for a propfan propulsion system. Alternatively, the driven rotor 26 may be configured as a generator rotor of an electric power generator for the aircraft electrical power system; e.g., an auxiliary power unit (APU) system. However, for ease of description, the mechanical load 22 is described below as a fan section 30 of the turbine engine 24, and the driven rotor 26 is described below as the fan rotor 28 within the fan section 30.

The turbine engine 24 has a centerline axis 32, and extends axially along the centerline axis 32 from an upstream end 33 of the turbine engine 24 to a downstream end 35 of the turbine engine 24. The turbine engine 24 of FIG. 1 includes the fan section 30 and a turbine engine core 34 (e.g., a gas generator) configured to power operation of the fan section 30. The engine core 34 includes a compressor section 36, a combustor section 37 and a turbine section 38. The compressor section 36 of FIG. 1 includes a low pressure compressor (LPC) section 36A and a high pressure compressor (HPC) section 37B. The turbine section 38 of FIG. 1 includes a high pressure turbine (HPT) section 38A and a low pressure turbine (LPT) section 38B.

The engine sections 30 and 36A-38B may be arranged sequentially along the centerline axis 32 within an engine housing 40. This engine housing 40 includes an inner case 42 (e.g., a core case) and an outer case 44 (e.g., a fan case). The inner case 42 may house one or more of the engine sections; e.g., the engine core 34. The outer case 44 may house at least the fan section 30.

The LPC section 36A includes a low pressure compressor (LPC) rotor 46. The HPC section 36B includes a high pressure compressor (HPC) rotor 47. The HPT section 38A includes a high pressure turbine (HPT) rotor 48. The LPT section 38B includes a low pressure turbine (LPT) rotor 49. Each of these engine rotors 46-49 and the fan rotor 28 includes a plurality of rotor blades arranged circumferentially around and connected to one or more respective rotor disks. The rotor blades, for example, may be formed integral with or mechanically fastened, welded, brazed and/or otherwise attached to the respective rotor disk(s).

The HPC rotor 47 is coupled to and rotatable with the HPT rotor 48. The HPC rotor 47 of FIG. 1, for example, is connected to the HPT rotor 48 by a high speed shaft 52. At least (or only) the HPC rotor 47, the HPT rotor 48 and the high speed shaft 52 collectively form a high speed rotating assembly 54; e.g., a high speed spool.

The LPC rotor 46 is coupled to and rotatable with the LPT rotor 49. The LPC rotor 46 of FIG. 1, for example, is connected to the LPT rotor 49 by a low speed shaft 56. At least (or only) the LPC rotor 46, the LPT rotor 49 and the low speed shaft 56 collectively form a low speed rotating assembly 58; e.g., a low speed spool. This low speed rotating assembly 58 is further coupled to the fan rotor 28 (the driven rotor 26) through a drivetrain 60. This drivetrain 60 may be configured as a geared drivetrain, where a geartrain 62 (e.g., a transmission, a speed change device, an epicyclic geartrain, etc.) is disposed between and operatively couples the fan rotor 28 to the low speed rotating assembly 58 and its LPT rotor 49. With this arrangement, the fan rotor 28 may rotate at a different (e.g., slower) rotational velocity than the low speed rotating assembly 58 and its LPT rotor 49. However, the drivetrain 60 may alternatively be configured as a direct drive drivetrain, where the geartrain 62 is omitted. With this arrangement, the fan rotor 28 rotates at a common (the same) rotational velocity as the low speed rotating assembly 58 and its LPT rotor 49.

Referring again to FIG. 1, each of the rotating assemblies 54 and 58 and its members is rotatably supported by a plurality of bearings 64; e.g., rolling element and/or thrust bearings. Each of these bearing 64 is connected to the engine housing 40 by at least one stationary structure such as, for example, a bearing support frame. Each of the rotating assemblies 54 and 58 and its members is thereby rotatable about a respective rotational axis. Each of these rotational axes may be parallel (e.g., coaxial) with the centerline axis 32.

During operation of the powerplant 20 of FIG. 1 (e.g., the aircraft propulsion system), air enters the powerplant 20 and its turbine engine 24 through an airflow inlet 66. This air is directed through the fan section 30 and into a core flowpath 68 (e.g., annular core flowpath) and a bypass flowpath 70 (e.g., annular bypass flowpath). The core flowpath 68 extends through the engine core 34 from an airflow inlet 72 into the core flowpath 68 to a combustion products exhaust 74 from the core flowpath 68. The engine core 34 of FIG. 1, for example, extends sequentially through the LPC section 36A, the HPC section 36B, the combustor section 37, the HPT section 38A and the LPT section 38B from the core inlet 72 to the core exhaust 74. The air within the core flowpath 68 may be referred to as “core air”. The bypass flowpath 70 extends through a bypass duct and bypasses (e.g., is radially outboard of and extends along) the engine core 34. The air within the bypass flowpath 70 may be referred to as “bypass air”.

The core air is compressed by the LPC rotor 46 and the HPC rotor 47 and directed into a combustion chamber 76 (e.g., an annular combustion chamber) of a combustor 78 (e.g., an annular combustor) in the combustor section 37. Fuel is injected into the combustion chamber 76 by one or more fuel injectors 80 and mixed with the compressed core air to provide a fuel-air mixture. This fuel-air mixture is ignited and combustion products thereof flow through and sequentially cause the HPT rotor 48 and the LPT rotor 49 to rotate. The rotation of the HPT rotor 48 and the LPT rotor 49 respectively drive rotation of the HPC rotor 47 and the LPC rotor 46 and, thus, compression of the air received from the core inlet 72. The rotation of the LPT rotor 49 also drives rotation of the fan rotor 28 (the driven rotor 26), which propels the bypass air through and out of the bypass flowpath 70. The propulsion of the bypass air may account for a majority of thrust generated by the aircraft propulsion system. Of course, where the mechanical load 22 also or alternatively includes the generator rotor, the rotation of the LPT rotor 49 may drive the electric power generator to generate electricity.

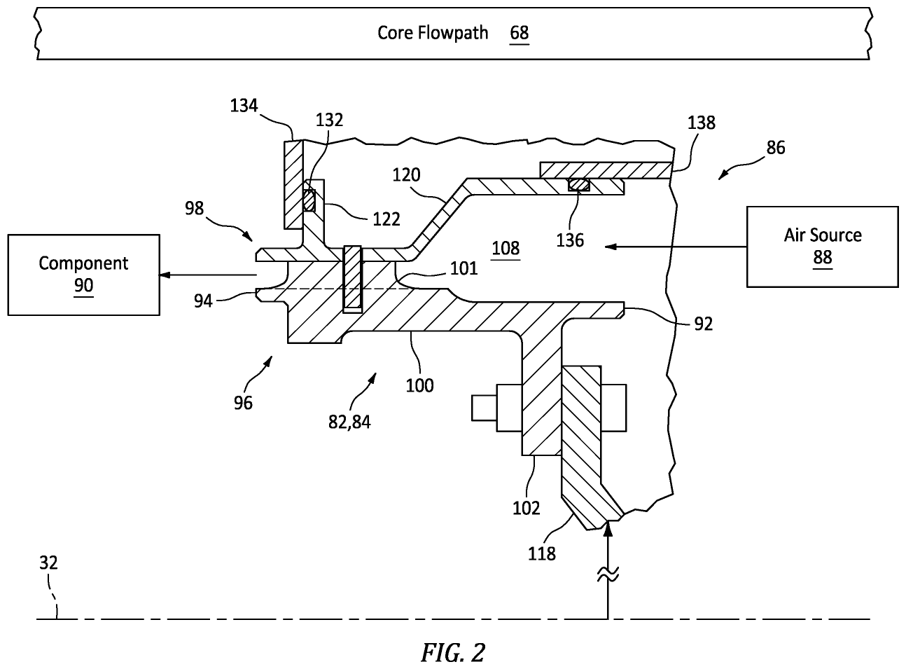

Referring to FIG. 2, the turbine engine 24 also includes a multi-piece nozzle 82 (e.g., an annular two-piece nozzle) such as an air injector nozzle 84; e.g., a tangential onboard injection (TOBI) nozzle. The injector nozzle 84 of FIG. 2 is included in an engine cooling air circuit 86 between a cooling air source 88 and an air cooled engine component 90. This injector nozzle 84 is configured to receive cooling air from the air source 88, and deliver the cooling air to the engine component 90 for cooling the engine component 90. The injector nozzle 84, for example, may direct the cooling air to impinge against the engine component 90. The injector nozzle 84 may also or alternatively direct the cooling air into one or more internal passages of the engine component 90. An example of the air source 88 is a bleed orifice along the core flowpath 68 (or the bypass flowpath 70) of FIG. 1. This bleed orifice may bleed air (e.g., compressed air) from one of the compressor sections 36A, 36B or a diffuser plenum surrounding the combustor 78 of FIG. 1. Examples of the engine component 90 include one of the engine rotors (e.g., 47 or 48) of FIG. 1. More particularly, the injector nozzle 84 may deliver the cooling air to a respective rotor disk of the engine rotor (e.g., 47 or 48). With such an exemplary arrangement, the injector nozzle 84 is discrete from and radially inboard of the core flowpath 68. The present disclosure, however, is not limited to such an exemplar arrangement. The injector nozzle 84, for example, may also or alternatively deliver the cooling air to one or more other components of the turbine engine 24; e.g., a seal element, a bearing element, etc.

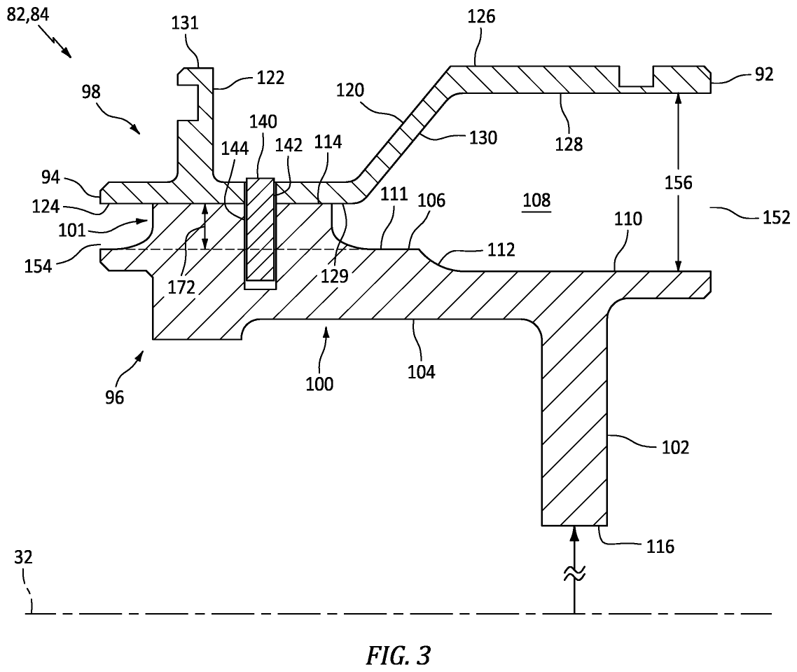

Referring to FIG. 3, the injector nozzle 84 extends axially along the centerline axis 32 between and to an upstream end 92 of the injector nozzle 84 and a downstream end 94 of the injector nozzle 84, where the centerline axis 32 may also be a centerline axis of the injector nozzle 84. Referring to FIG. 2, the nozzle upstream end 92 may be an axial aft end of the injector nozzle 84 and the nozzle downstream end 94 may be an axial forward end of the injector nozzle 84 where the injector nozzle 84 is axially aft of the engine component 90 along the centerline axis 32. With such an arrangement, the engine component 90 may be configured as the HPC rotor 47 (see FIG. 1). Alternatively, the nozzle upstream end 92 may be an axial forward end of the injector nozzle 84 and the nozzle downstream end 94 may be an axial aft end of the injector nozzle 84 where the injector nozzle 84 is axially forward of the engine component 90 along the centerline axis 32. With such an arrangement, the engine component 90 may be configured as the HPT rotor 48 (see FIG. 1). Referring again to FIG. 3, the injector nozzle 84 includes an inner nozzle structure 96 and an outer nozzle structure 98.

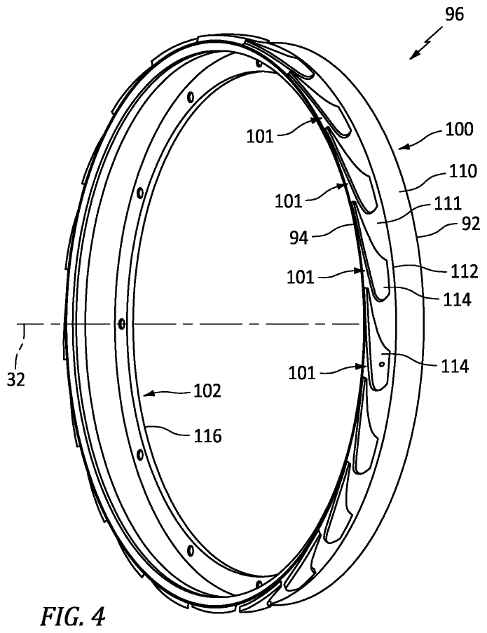

The inner nozzle structure 96 of FIG. 3 includes an inner shroud 100 (e.g., a tubular inner shroud) and a plurality of nozzle vanes 101; see also FIG. 4. The inner nozzle structure 96 of FIG. 3 also includes an inner flange 102 (e.g., annular inner flange).

The inner shroud 100 extends axially along the centerline axis 32 between and to the nozzle upstream end 92 and the nozzle downstream end 94. The inner shroud 100 extends circumferentially about (e.g., completely around) the centerline axis 32. The inner shroud 100 of FIG. 4, for example, has a full-hoop (e.g., tubular) geometry about the centerline axis 32. Referring to FIG. 3, the inner shroud 100 extends radially between and to an inner side 104 of the inner shroud 100 and an outer side 106 of the inner shroud 100. With this arrangement, the inner shroud outer side 106 forms an inner peripheral boundary of a nozzle flowpath 108 axially through the injector nozzle 84.

The inner shroud 100 of FIG. 3 includes an upstream surface 110, a downstream surface 111 and an intermediate surface 112. Each of these inner shroud surfaces 110-112 forms a respective axial section of the inner peripheral boundary of the nozzle flowpath 108. The inner shroud upstream surface 110 is disposed at (e.g., on, adjacent or proximate) the nozzle upstream end 92. The inner shroud upstream surface 110 of FIG. 3, for example, extends axially along the centerline axis 32 from the inner shroud intermediate surface 112 to the nozzle upstream end 92. The inner shroud downstream surface 111 is disposed at the nozzle downstream end 94. The inner shroud downstream surface 111 of FIG. 3, for example, extends axially along the centerline axis 32 from the inner shroud intermediate surface 112 to the nozzle downstream end 94. The inner shroud intermediate surface 112 extends axially and radially between the inner shroud upstream surface 110 and the inner shroud downstream surface 111. The inner shroud intermediate surface 112 of FIG. 3, for example, is configured as a radially tapered surface that tapers radially inward towards the centerline axis 32 as the inner shroud intermediate surface 112 extend axially from (or about) the inner shroud downstream surface 111 to (or about) the inner shroud upstream surface 110. With this arrangement, the inner shroud downstream surface 111 is disposed radially outboard of the inner shroud upstream surface 110.

The inner shroud upstream surface 110 and the inner shroud downstream surface 111 may each be configured as a cylindrical surface. More particularly, the inner shroud upstream surface 110 and the inner shroud downstream surface 111 each have a straight-line sectional geometry when viewed, for example, in a reference plane parallel with (e.g., including) the centerline axis 32, where each inner shroud surface 110, 111 is parallel with the centerline axis 32. The inner shroud upstream surface 110 and the inner shroud downstream surface 111 each also have a uniform (the same) radius about the centerline axis 32. The inner shroud intermediate surface 112, by contrast, may have a straight-line sectional geometry or a curved sectional geometry when viewed, for example, in the reference plane, where the inner shroud intermediate surface 112 is angularly offset from the centerline axis 32. The present disclosure, however, is not limited to such an exemplary arrangement. One or more of the inner shroud surfaces 110 and/or 112, for example, may be omitted from the inner shroud 100.

Referring to FIG. 4, the nozzle vanes 101 are arranged (e.g., equispaced) circumferentially about the centerline axis 32 and the inner shroud 100 in an annular array; e.g., a circular array. Each of the nozzle vanes 101 is connected to (e.g., formed integral with) the inner shroud 100 may be axially aligned with the inner shroud downstream surface 111. Each nozzle vane 101 of FIG. 3, for example, projects radially out (in an outward direction away from the centerline axis 32) from the inner shroud 100 and its inner shroud downstream surface 111 to an outer distal end 114 of the respective nozzle vane 101. The nozzle vane array of FIG. 4 and each of its nozzle vanes 101 are axially spaced from the nozzle downstream end 94 and the inner shroud intermediate surface 112. The nozzle vane array and each of its nozzle vanes 101, however, may alternatively extend axially to the nozzle downstream end 94 and/or the inner shroud intermediate surface 112 in other embodiments.

Referring to FIG. 3, the inner flange 102 is connected to (e.g., formed integral with) the inner shroud 100. The inner flange 102 of FIG. 3, for example, projects radially out (in an inward direction towards the centerline axis 32) from the inner shroud 100 to an inner distal end 116 of the inner flange 102. The inner flange 102 is axially offset from (e.g., axially spaced from) the nozzle vane array and each of its nozzle vanes 101 along the centerline axis 32. The inner flange 102 of FIG. 3, for example, is located radially opposite and axially aligned with the inner shroud upstream surface 110. The inner flange 102 extends circumferentially about (e.g., completely around) the centerline axis 32. The inner flange 102 of FIG. 4, for example, has a full-hoop (e.g., annular) geometry about the centerline axis 32. With this arrangement, referring to FIG. 2, the inner flange 102 may form a mount for attaching the injector nozzle 84 to a stationary structure 118 within the turbine engine 24.

The inner nozzle structure 96 of FIGS. 3 and 4 is configured as a monolithic body. The term “monolithic” may describe a body which is formed from a continuous mass of material. The inner nozzle structure 96, for example, may be machined and/or otherwise formed from a ring of material (e.g., a forged metal ring) to provide the inner nozzle structure 96 and each of its members 100-102. By contrast, a non-monolithic body includes a plurality of discretely formed bodies which are joined (e.g., welded) together to form a single component. The inner nozzle structure 96 may be formed from various metals such as, but not limited to, aluminum (Al), nickel (Ni), titanium (Ti), an alloy thereof, or steel.

Referring to FIG. 3, the outer nozzle structure 98 may be configured as or otherwise include an outer shroud 120; e.g., a tubular outer shroud. The outer nozzle structure 98 of FIG. 3 also includes an outer flange 122; e.g., annular outer flange.

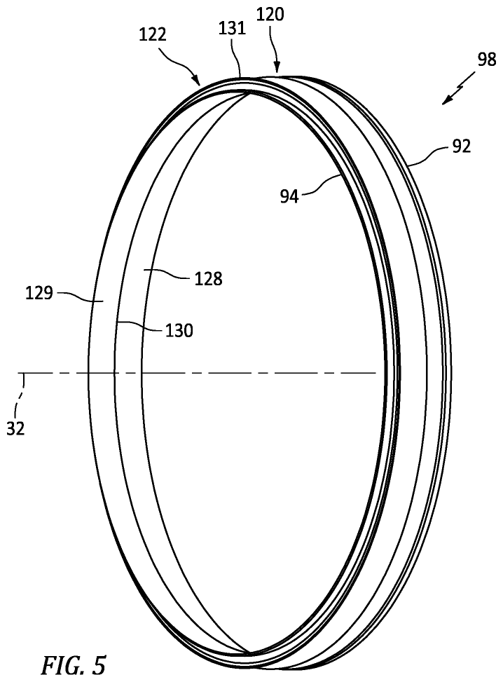

The outer shroud 120 extends axially along the centerline axis 32 between and to the nozzle upstream end 92 and the nozzle downstream end 94. The outer shroud 120 extends circumferentially about (e.g., completely around) the centerline axis 32. The outer shroud 120 of FIG. 5, for example, has a full-hoop (e.g., tubular) geometry about the centerline axis 32. Referring to FIG. 3, the outer shroud 120 extends radially between and to an inner side 124 of the outer shroud 120 and an outer side 126 of the outer shroud 120. With this arrangement, the outer shroud inner side 124 forms an outer peripheral boundary of the nozzle flowpath 108 axially through the injector nozzle 84.

The outer shroud 120 of FIG. 3 includes an upstream surface 128, a downstream surface 129 and an intermediate surface 130. Each of these outer shroud surfaces 128-130 forms a respective axial section of the outer peripheral boundary of the nozzle flowpath 108. The outer shroud upstream surface 128 is disposed at (e.g., on, adjacent or proximate) the nozzle upstream end 92. The outer shroud upstream surface 128 of FIG. 3, for example, extends axially along the centerline axis 32 from the outer shroud intermediate surface 130 to the nozzle upstream end 92. The outer shroud downstream surface 129 is disposed at the nozzle downstream end 94. The outer shroud downstream surface 129 of FIG. 3, for example, extends axially along the centerline axis 32 from the outer shroud intermediate surface 130 to the nozzle downstream end 94. The outer shroud intermediate surface 130 extends axially and radially between the outer shroud upstream surface 128 and the outer shroud downstream surface 129. The outer shroud intermediate surface 130 of FIG. 3, for example, is configured as a radially tapered surface that tapers radially inward towards the centerline axis 32 as the outer shroud intermediate surface 130 extend axially from (or about) the outer shroud upstream surface 128 to (or about) the outer shroud downstream surface 129. With this arrangement, the outer shroud upstream surface 128 is disposed radially outboard of the outer shroud downstream surface 129.

The outer shroud upstream surface 128 and the outer shroud downstream surface 129 may each be configured as a cylindrical surface. More particularly, the outer shroud upstream surface 128 and the outer shroud downstream surface 129 each have a straight-line sectional geometry when viewed, for example, in the reference plane, where each outer shroud surface 128, 129 is parallel with the centerline axis 32. The outer shroud upstream surface 128 and the outer shroud downstream surface 129 each also have a uniform (the same) radius about the centerline axis 32. The outer shroud intermediate surface 130, by contrast, may have a straight-line sectional geometry or a curved sectional geometry when viewed, for example, in the reference plane, where the outer shroud intermediate surface 130 is angularly offset from the centerline axis 32. The present disclosure, however, is not limited to such an exemplary arrangement. One or more of the outer shroud surfaces 128 and/or 130, for example, may be omitted from the outer shroud 120.

Referring to FIG. 3, the outer flange 122 is connected to (e.g., formed integral with) the outer platform 120. The outer flange 122 of FIG. 3, for example, projects radially out (in an outward direction away from the centerline axis 32) from the outer platform 120 to an outer distal end 131 of the outer flange 122. The outer flange 122 is located radially opposite and axially aligned with the outer platform downstream surface 129. The outer flange 122 extends circumferentially about (e.g., completely around) the centerline axis 32. The outer flange 122 of FIG. 5, for example, has a full-hoop (e.g., annular) geometry about the centerline axis 32. With this arrangement, referring to FIG. 2, the outer flange 122 may form a seal land and/or a seal mount for a seal element 132 (e.g., a seal ring such as an O-ring) engaged with and axially between the outer flange 122 and another stationary structure 134 within the turbine engine 24. Note, another seal element 136 may also be engaged with and radially between the outer platform 120 and still another stationary structure 138 within the turbine engine 24.

The outer nozzle structure 98 of FIGS. 3 and 5 is configured as a monolithic body. The outer nozzle structure 98, for example, may be machined and/or otherwise formed from a ring of material (e.g., a forged metal ring) to provide the outer nozzle structure 98 and each of its members 120 and 122. The outer nozzle structure 98 may be formed from various metals such as, but not limited to, aluminum (Al), nickel (Ni), titanium (Ti), an alloy thereof, or steel. This outer nozzle structure material (e.g., metal) may be the same or different than the inner nozzle structure material.

Referring to FIG. 3, the outer nozzle structure 98 is mounted to the inner nozzle structure 96. The outer nozzle structure 98 and its outer shroud 120 of FIG. 3, for example, are press fit onto the inner nozzle structure 96 and its nozzle vanes 101. An interference fit between the outer shroud 120 and each respective nozzle vane 101 may thereby mechanically fasten the outer nozzle structure 98 to the inner nozzle structure 96. With this arrangement, each nozzle vane 101 of FIG. 3 extends radially to the outer shroud 120. Each vane outer distal end 114 is radially engaged with (e.g., radially abutted against, pressed radially against) the outer shroud downstream surface 129. Here, the outer flange 122 is axially aligned with (e.g., axially overlaps) the nozzle vane array and each of its nozzle vanes 101. Moreover, the interference fit may provide a sealed interface between each nozzle vane 101 and the outer shroud 120 and its outer shroud downstream surface 129. This seal interface may prevent air from leaking across the vane outer distal end 114 radially between the respective nozzle vane 101 and the outer shroud downstream surface 129.

The outer nozzle structure 98 may also (or alternatively) be mechanically fastened to the inner nozzle structure 96 with one or more fasteners 140 (one visible in FIG. 3) arranged circumferentially about the centerline axis 32. Each fastener 140 of FIG. 3 is mated with (e.g., disposed in) a respective outer aperture 142 in the outer nozzle structure 98 and a respective inner aperture 144 in the inner nozzle structure 96. The outer aperture 142 of FIG. 3 projects radially through the outer nozzle structure 98 and its outer shroud 120. The inner aperture 144 of FIG. 3 projects (e.g., partially) radially into the inner nozzle structure 96. More particularly, the inner aperture 144 of FIG. 3 projects radially through a respective one of the nozzle vanes 101 and (e.g., partially) into the inner shroud 100. With this arrangement, the fastener 140 of FIG. 3 extends radially out of (e.g., through) the outer aperture 142 and into the inner aperture 144 to axially and rotationally fix the outer nozzle structure 98 to the inner nozzle structure 96. Examples of the fastener 140 include, but are not limited to, a pin, a set screw, a bolt and the like.

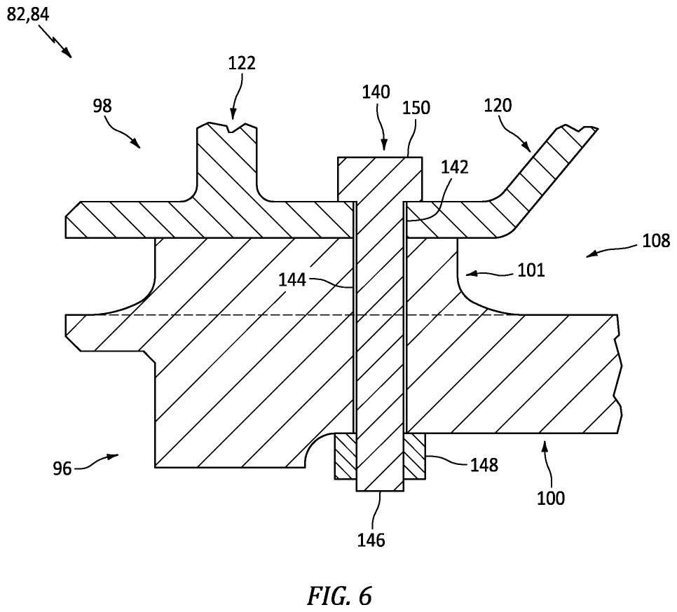

While the fastener 140 of FIG. 3 projects partially into the inner nozzle structure 96, the present disclosure is not limited to such an exemplary arrangement. For example, the inner aperture 144 of FIG. 6 projects radially through the inner nozzle structure 96 and its respective members 100 and 101. With this arrangement, the fastener 140 of FIG. 6 may extend radially out of (e.g., through) the outer aperture 142 and through the inner aperture 144. Here, a distal end 146 of the fastener 140 of FIG. 6 is mated with (e.g., threaded into) a nut 148, such that the inner nozzle structure 96 and the outer nozzle structure 98 are retained between the nut 148 and a head 150 of the fastener 140. Of course, various other fasteners and fastening techniques are known in the art, and the present disclosure is not limited to any particular ones thereof.

Referring to FIG. 3, the nozzle flowpath 108 extends axially through the injector nozzle 84 from an inlet 152 into the nozzle flowpath 108 at the nozzle upstream end 92 to an outlet 154 from the nozzle flowpath 108 at the nozzle downstream end 94. This nozzle flowpath 108 is radially bounded by the inner shroud 100 and the outer shroud 120. The nozzle flowpath 108 of FIG. 3 radially tapers as the nozzle flowpath 108 extends axially within the injector nozzle 84 towards the nozzle flowpath outlet 154/the nozzle downstream end 94. A radial height 156 of the nozzle flowpath 108 between the inner shroud 100 and the outer shroud 120 of FIG. 3, for example, radially decreases as the nozzle flowpath 108 extends towards (or to) the nozzle vanes 101 and/or the nozzle downstream end 94, for example along the inner shroud intermediate surface 112 and/or the outer shroud intermediate surface 130.

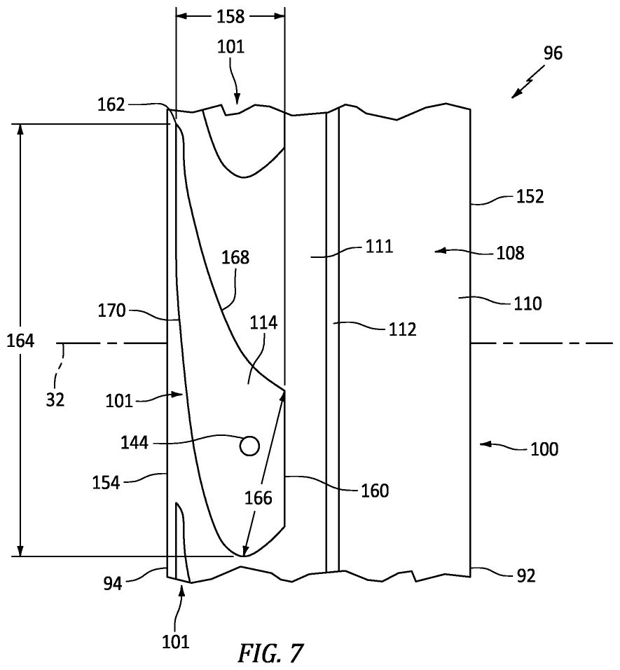

Referring to FIG. 7, each nozzle vane 101 has an (e.g., overall, maximum) axial length 158 along the centerline axis 32, for example generally axially between a leading end 160 and a trailing edge 162 of the respective nozzle vane 101. Each nozzle vane 101 has a (e.g., overall, maximum) circumferential width 164 about the centerline axis 32. Each nozzle vane 101 has a (e.g., overall, maximum) lateral thickness 166 between a first (e.g., concave, pressure) side 168 of the respective nozzle vane 101 and a second (e.g., convex, suction) side 170 of the respective nozzle vane 101. Referring to FIG. 3, each nozzle vane 101 has a radial height 172 (e.g., a span) from the inner shroud 100 and its inner shroud downstream surface 111 to the outer shroud 120 and its outer shroud downstream surface 129. This radial height 172 of FIG. 3 may be sized smaller than the axial length 158, the circumferential width 164 and/or the lateral thickness 166 of FIG. 7.

While the nozzle 82 is described above as the injector nozzle 84, the present disclosure is not limited to such an exemplary embodiment. It is contemplated, for example, the nozzle 82 may be utilized as another type of nozzle/vane array within the turbine engine 24.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

1. An apparatus for a turbine engine, comprising:
an annular nozzle including an inner monolithic body and an outer monolithic body;
the inner monolithic body including an inner shroud and a plurality of vanes, the inner shroud extending axially along and circumferentially around an axis, the plurality of vanes arranged circumferentially about the axis in an array, and each of the plurality of vanes projecting radially out from the inner shroud to a respective outer distal end; and
the outer monolithic body radially outboard of and circumscribing the inner monolithic body, the outer monolithic body comprising an outer shroud, the outer shroud extending axially along and circumferentially around the axis, and the outer shroud radially engaging each of the plurality of vanes at the respective outer distal end.

2. The apparatus of claim 1, wherein
the plurality of vanes comprise a first vane;
the first vane has an axial length along the axis; and
the first vane has a radial height between the inner shroud and the outer shroud which is less than the axial length.

3. The apparatus of claim 1, wherein
the plurality of vanes comprise a first vane;
the first vane has a circumferential width about the axis; and
the first vane has a radial height between the inner shroud and the outer shroud which is less than the circumferential width.

4. The apparatus of claim 1, wherein
the plurality of vanes comprise a first vane;
the first vane has a lateral thickness; and
the first vane has a radial height between the inner shroud and the outer shroud which is less than the lateral thickness.

5. The apparatus of claim 1, wherein
the inner shroud forms an outer peripheral boundary of a flowpath through the annular nozzle, and the inner shroud includes a first surface and a second surface;
the first surface extends circumferentially around the axis and is upstream of the second surface along the flowpath;
the second surface extends circumferentially around the axis and is radially outboard of the first surface; and
the plurality of vanes project radially out from the second surface.

6. The apparatus of claim 1, wherein
the outer shroud forms an inner peripheral boundary of a flowpath through the annular nozzle, and the outer shroud includes a first surface and a second surface;
the first surface extends circumferentially around the axis and is upstream of the second surface along the flowpath; and
the second surface extends circumferentially around the axis and is radially inboard of the first surface, and the second surface radially abuts each of the plurality of vanes at the respective outer distal end.

7. The apparatus of claim 1, wherein
the inner shroud forms an outer peripheral boundary of a flowpath through the annular nozzle;
the outer shroud forms an inner peripheral boundary of the flowpath through the annular nozzle;
each of the plurality of vanes extends radially across the flowpath; and
a radial height of the flowpath decreases as the flowpath extends axially within the annular nozzle towards the plurality of vanes.

8. The apparatus of claim 1, wherein the outer monolithic body is mechanically fastened to the inner monolithic body.

9. The apparatus of claim 1, wherein the outer monolithic body is attached to the inner monolithic body by an interference fit between the outer shroud and the plurality of vanes.

10. The apparatus of claim 1, wherein a fastener extends radially in an outer aperture of the outer monolithic body and into an inner aperture of the inner monolithic body.

11. The apparatus of claim 10, wherein the outer aperture of the outer monolithic body extends radially through the outer shroud.

12. The apparatus of claim 10, wherein the inner aperture of the inner monolithic body extends radially in a first of the plurality of vanes.

13. The apparatus of claim 10, wherein the inner aperture of the inner monolithic body extends radially through a first of the plurality of vanes and into the inner shroud.

14. The apparatus of claim 1, wherein
the inner monolithic body further includes an inner flange;
the inner flange is axially spaced from the plurality of vanes; and
the inner flange projects radially inward towards the axis from the inner shroud.

15. The apparatus of claim 1, wherein
the outer monolithic body further includes an outer flange;
the outer flange is axially aligned with the plurality of vanes; and
the outer flange projects radially outward away from the axis from the outer shroud.

16. The apparatus of claim 1, wherein the annular nozzle is configured as a tangential onboard injector.

17. The apparatus of claim 1, further comprising:
a compressor section;
a combustor section;
a turbine section;
a flowpath extending sequentially through the compressor section, the combustor section and the turbine section, and the flowpath disposed radially outboard of the annular nozzle; and
a bladed rotor rotatable about the axis, the annular nozzle configured to direct air bled from the flowpath to the bladed rotor.

18. (canceled)

19. An apparatus for a turbine engine, comprising:
a tangential onboard injector nozzle including an inner nozzle structure and an outer nozzle structure;
the inner nozzle structure including an inner shroud and a plurality of vanes formed integral with the inner shroud, the inner shroud extending axially along and circumferentially around an axis, the plurality of vanes arranged circumferentially about the axis in an array, and each of the plurality of vanes projecting radially outward away from the axis from the inner shroud, the inner nozzle structure configured as a unitary body; and
the outer nozzle structure radially outboard of, circumscribing, and mounted to the inner nozzle structure, the outer nozzle structure comprising an outer shroud, the outer shroud extending axially along and circumferentially around the axis, and the outer shroud abutted radially against each of the plurality of vanes.

20. (canceled)

21. An apparatus for a turbine engine, comprising:
an annular nozzle including an inner monolithic body and an outer monolithic body;
the inner monolithic body including an inner shroud and a plurality of vanes formed with the inner shroud into the inner monolithic body, the inner shroud extending axially along and circumferentially around an axis, the plurality of vanes arranged circumferentially about the axis in an array, and each of the plurality of vanes projecting radially out from the inner shroud to a respective outer distal end;
the outer monolithic body radially outboard of and circumscribing the inner monolithic body, the outer monolithic body comprising an outer shroud, the outer shroud extending axially along and circumferentially around the axis, and the outer shroud radially engaging each of the plurality of vanes at the respective outer distal end; and
the plurality of vanes comprising a first vane, the first vane including a lateral thickness and a radial height, and the radial height between the inner shroud and the outer shroud is less than the lateral thickness.

22. The apparatus of claim 1, wherein at least the inner shroud and the plurality of vanes are formed from a single continuous mass of material to define the inner monolithic body.
